(19) United States
(12) Patent Application Publication
(10) Pub. No.: US 2018/0146213 A1
(43) Pub. Date: May 24, 2018

(54) FILTERING FOR VIDEO PROCESSING

(71) Applicant: TELEFONAKTIEBOLAGET LM ERICSSON (PUBL), Stockholm (SE)

(72) Inventors: Kenneth ANDERSSON, Gävle (SE); Martin PETTERSSON, Vallentuna (SE); Jonatan SAMUELSSON, Enskede (SE); Rickard SJÖBERG, Stockholm (SE); Jacob STRÖM, Stockholm (SE)

(73) Assignee: TELEFONAKTIEBOLAGET LM ERICSSON (PUBL), Stockholm (SE)

(21) Appl. No.: 15/579,447

(22) PCT Filed: Jun. 3, 2016
(86) PCT No.: PCT/SE2016/050533

§ 371 Date: Dec. 4, 2017

Related U.S. Application Data
(60) Provisional application No. 62/171,529, filed on Jun. 5, 2015.

(51) Int. Cl. H04N 19/82; H04N 19/593; H04N 19/186

(52) U.S. Cl. CPC H04N 19/82; H04N 19/186; H04N 19/593

(57) ABSTRACT

It is presented a method for applying a filter on at least one colour component of an input signal used for video processing. The method is performed in a filter device and comprises the steps of: converting the input signal, by applying a first conversion process, to a modified signal, wherein both the input signal and the modified signal are in a spatial domain; filtering the modified signal with a filter, yielding a filtered signal; and converting the filtered signal, by applying a second conversion process, to an output signal, wherein the output signal is in a spatial domain.

### TECHNICAL FIELD

The invention relates to methods, filter devices, computer programs and computer program products for applying a filter of at least one colour component for video processing.

### BACKGROUND

In video processing, filters are used for many purposes. For instance, filters can be used in an encoder, a decoder, etc.

For instance, interpolation filters have been designed to have some specific property based on frequency domain and/or spatial domain. Interpolation filters used in video coding standards typically have fixed coefficients for respective sub-pixel interpolation such as half-pel interpolation and quarter-pel interpolation etc. Adaptive interpolations filters have also been used. In that case filter coefficients for a specific sub-pixel interpolation is optimized such that the motion compensated prediction error is minimized. In loop-filtering, adaptive filters have been used. In that case the filter coefficients are optimized to minimize the reconstruction error in a certain region and also for sample values with specific edge properties. Reconstruction corresponds typically to the stage after a residual have been added to the motion compensated prediction and also deblocking filtering and other in-loop filters may have been used.

### SUMMARY

It is an object to improve how filtering is done for video processing.

According to a first aspect, it is presented a method for applying a filter on at least one colour component of an input signal used for video processing. The method is performed in a filter device and comprises the steps of: converting the input signal, by applying a first conversion process, to a modified signal, wherein both the input signal and the modified signal are in a spatial domain; filtering the modified signal with a filter, yielding a filtered signal; and converting the filtered signal, by applying a second conversion process, to an output signal, wherein the output signal is in a spatial domain.

The input signal and the output signal may be in a first representation and the modified signal may be in a second representation, wherein the first representation is more compression efficient than the second representation and wherein the second representation is more suitable than the first representation for applying filters.

The second conversion process may be an inverse of the first conversion process.

The modified signal may be a more linear representation of intensity of a physical entity than the input signal and the output signal.

The modified signal may be a colour and intensity representation in red, green and blue, RGB, and the input signal and the output signal may be luma, blue-difference chroma and red difference chroma, YC_{B}C_{R}.

The input signal may comprise samples for a spatial element and the modified signal may comprise corresponding samples for a corresponding spatial element.

The step of filtering may comprise calculating values for each sample of the filtered signal, based on values for the samples in the modified signal.

The step of filtering may comprise applying a de-blocking filter.

The step of filtering may comprise applying a weighted prediction wherein particular weighting factors and/or weighting offsets are applied to one or more predictions to form a final prediction.

The step of filtering may comprise performing filtering for motion compensation using one reference or two references.

The step of filtering may comprise performing an intra prediction filtering process.

The step of filtering may comprise performing a resampling process between two different resolutions.

The step of filtering may comprise performing a conversion between two colour spaces.

According to a second aspect, it is presented a filter device for applying a filter on at least one colour component of an input signal used for video processing. The filter device comprises processing means and a memory comprising instructions which, when executed by the processing means, causes the filter device to: convert the input signal, by applying a first conversion process, to a modified signal, wherein both the input signal and the modified signal are in a spatial domain; filter the modified signal with a filter, yielding a filtered signal; and convert the filtered signal, by applying a second conversion process, to an output signal, wherein the output signal is in a spatial domain.

The input signal and the output signal may be in a first representation and the modified signal may be in a second representation, wherein the first representation is more compression efficient than the second representation and wherein the second representation is more suitable than the first representation for applying filters.

The second conversion process may be an inverse of the first conversion process.

The modified signal may be a more linear representation of intensity of a physical entity than the input signal and the output signal.

The modified signal may be a colour and intensity representation in red, green and blue, RGB, and the input signal and the output signal may be luma, blue-difference chroma and red difference chroma, YC_{B}C_{R}.

The input signal may comprise samples for a spatial element and the modified signal may comprise corresponding samples for a corresponding spatial element.

The instructions to filter may comprise instructions which, when executed by the processing means, causes the filter device to calculate values for each sample of the filtered signal, based on values for the samples in the modified signal.

The instructions to filter may comprise instructions which, when executed by the processing means, causes the filter device to apply a de-blocking filter.

The instructions to filter may comprise instructions which, when executed by the processing means, causes the filter device to apply a weighted prediction wherein particular weighting factors and/or weighting offsets are applied to one or more predictions to form a final prediction.

The instructions to filter may comprise instructions which, when executed by the processing means, causes the filter device to perform filtering for motion compensation using one reference or two references.

The instructions to filter may comprise instructions which, when executed by the processing means, causes the filter device to perform an intra prediction filtering process.

The instructions to filter may comprise instructions which, when executed by the processing means, causes the filter device to perform a resampling process between two different resolutions.

The instructions to filter may comprise instructions which, when executed by the processing means, causes the filter device to perform a conversion between two colour spaces.

According to a third aspect, it is presented a filter device comprising: means for converting an input signal used for video processing, by applying a first conversion process, to a modified signal, wherein both the input signal and the modified signal are in a spatial domain; means for filtering the modified signal with a filter on at least one colour component, yielding a filtered signal; and means for converting the filtered signal, by applying a second conversion process, to an output signal, wherein the output signal is in a spatial domain.

According to a fourth aspect, it is presented an encoder comprising the filter device according to the second aspect or the third aspect. The encoder could alternatively or additionally comprise the filter device according to the ninth or tenth aspect presented below.

According to a fifth aspect, it is presented a decoder comprising the filter device according to the second aspect or the third aspect. The decoder could alternatively or additionally comprise the filter device according to the ninth or tenth aspect presented below.

According to a sixth aspect, it is presented a computer program for applying a filter on at least one colour component of an input signal used for video processing. The computer program comprises computer program code which, when run on a filter device causes the filter device to: convert the input signal, by applying a first conversion process, to a modified signal, wherein both the input signal and the modified signal are in a spatial domain; filter the modified signal with a filter, yielding a filtered signal; and convert the filtered signal, by applying a second conversion process, to an output signal, wherein the output signal is in a spatial domain.

According to a seventh aspect, it is presented a computer program product comprising a computer program according to the sixth aspect and a computer readable means on which the computer program is stored.

According to an eighth aspect, it is presented a method for applying a filter on at least one colour component of an input signal used for video processing. The method is performed in a filter device and comprises the steps of: determining an output using a lookup table, wherein the output corresponds to an approximation of an output obtained by: converting the input signal, by applying a first conversion process, to a modified signal, wherein both the input signal and the modified signal are in a spatial domain; filtering the modified signal with a filter, yielding a filtered signal; and converting the filtered signal, by applying a second conversion process, to the output signal, wherein the output signal is in a spatial domain.

The step of determining an output may comprise the use of the following formula:

$$vo = \frac{{\sum }_{n = 0}^{N - 1} w 1 ( n ) * lookuptable ( v ( n ) / step ) * v ( n )}{{\sum }_{n = 0}^{N - 1} w 1 ( n ) * lookuptable ( v ( n ) / step )} ,$$

where vo is the output, w1 is a vector for filter coefficients, N is the length of the filter w1, v is a vector of the input signal and step is the distance between values of the lookup table.

The modified signal may be a more linear representation of intensity of a physical entity than the input signal and the output signal.

According to a ninth aspect, it is presented a filter device for applying a filter on at least one colour component of an input signal used for video processing.

The filter device comprises processing means and a memory comprising instructions which, when executed by the processing means, causes the filter device to: determine an output using a lookup table, wherein the output corresponds to an approximation of an output obtained by: converting the input signal, by applying a first conversion process, to a modified signal, wherein both the input signal and the modified signal are in a spatial domain; filtering the modified signal with a filter, yielding a filtered signal; and converting the filtered signal, by applying a second conversion process, to the output signal, wherein the output signal is in a spatial domain.

The instructions to determine an output may comprise instructions which, when executed by the processing means, causes the filter device to use of the following formula:

$$vo = \frac{{\sum }_{n = 0}^{N - 1} w 1 ( n ) * lookuptable ( v ( n ) / step ) * v ( n )}{{\sum }_{n = 0}^{N - 1} w 1 ( n ) * lookuptable ( v ( n ) / step )} ,$$

where vo is the output, w1 is a vector for filter coefficients, N is the length of the filter w1, v is a vector of the input signal and step is the distance between values of the lookup table.

The modified signal may be a more linear representation of intensity of a physical entity than the input signal and the output signal.

According to a tenth aspect, it is presented a filter device comprising: means for determining an output using a lookup table, wherein the output corresponds to an approximation of an output obtained by: converting an input signal used for video processing, by applying a first conversion process, to a modified signal, wherein both the input signal and the modified signal are in a spatial domain; filtering the modified signal with a filter, yielding a filtered signal; and converting the filtered signal, by applying a second conversion process, to the output signal, wherein the output signal is in a spatial domain.

According to an eleventh aspect, it is presented a computer program for applying a filter on at least one colour component of an input signal used for video processing, the computer program comprising computer program code which, when run on a filter device causes the filter device to: determine an output using a lookup table, wherein the output corresponds to an approximation of an output obtained by: converting the input signal, by applying a first conversion process, to a modified signal, wherein both the input signal and the modified signal are in a spatial domain; filtering the modified signal with a filter, yielding a filtered signal; and converting the filtered signal, by applying a second conversion process, to the output signal, wherein the output signal is in a spatial domain.

According to a twelfth aspect, it is presented a computer program product comprising a computer program according to the eleventh aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates brightness perception of the human eye as a function of luminance;

FIG. 2 illustrates how luminance depends on perceived brightness;

FIG. 3(a) illustrates interpolation of linear samples, whereas FIG. 3(b) illustrates two alternatives for interpolation of non-linear samples: the dashed alternative maintains the linear properties of a signal after converting it to a linear domain, whereas the solid alternative does not;

FIG. 4 illustrates a case where the filter is applied in a linear domain according to an embodiment of the present invention. FIG. 4(a) illustrates the samples in a non-linear domain, FIG. 4(b) illustrates the samples in a linear domain, and FIG. 4(c) illustrates the filtered samples in the non-linear domain;

FIGS. 5 and 6 are flow chart illustrating embodiments of methods for applying a filter on at least one colour component of an input signal used for video processing;

FIG. 7 is a schematic diagram illustrating an environment with an encoder and a decoder, in which embodiments presented herein can be implemented;

FIG. 8 is a schematic diagram illustrating some components of any one of the filter devices of FIG. 7 according to one embodiment;

FIG. 9 is a schematic diagram illustrating functional modules of any one of the filter devices of FIG. 7 according to one embodiment; and

FIG. 10 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Embodiments presented herein are based on the realisation that filtering signals in a non-linear domain greatly improves performance.

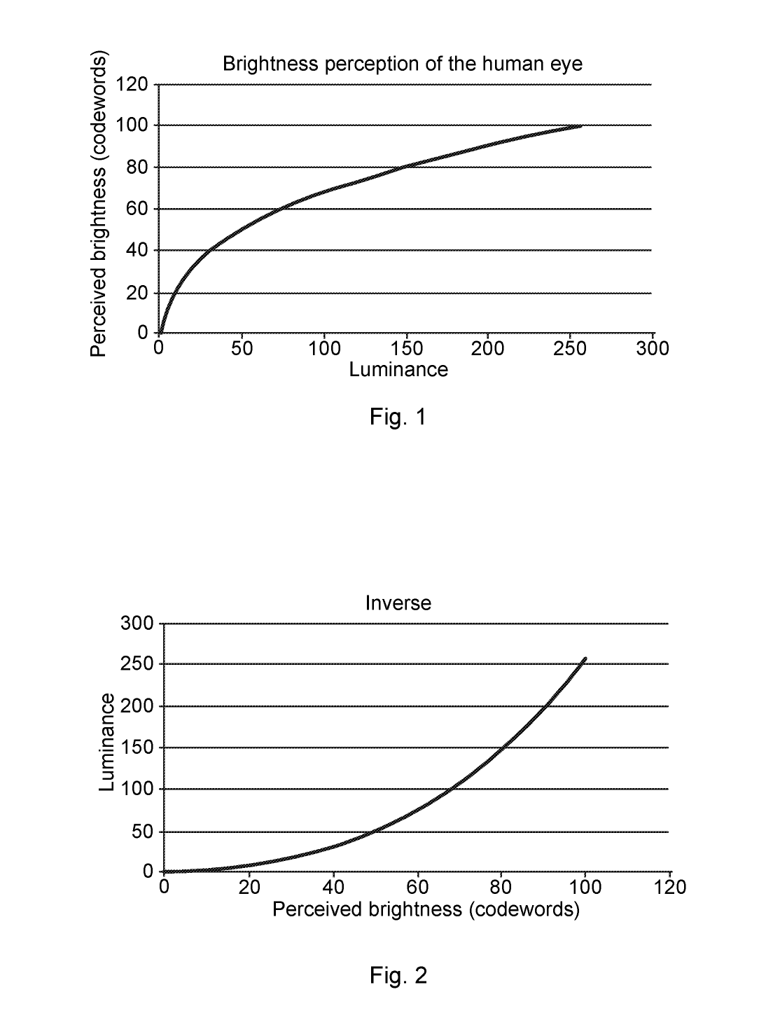

Non-linear samples are typically used in video coding where a transfer function (TF, OptoElectricalTF, gamma compensation etc.) have been applied to linear samples before they are coded. Then an inverse function is deployed before linear light (in candela/m2) is emitted from the display. One effect of this is that then video compression is done in a domain that better corresponds to the human visual system. FIGS. 1 and 2 show how the perceived brightness depends on the actual luminance. FIG. 2 is the inverse of FIG. 1. The figures show that the human eye is more sensitive in the dark, low luminance part, than in the bright, high luminance part. The video coder applies compression on non-linear samples. Coding errors of the same magnitude will be perceived more equal in the dark and in the bright if coding is done in the non-linear domain. If coding is done in the linear domain, errors in the dark will be easily visible and a very high bitrate would be needed to make the dark look good.

In video coding, interpolation is used in inter-picture coding to align a block of a reference picture with the block of the current picture if the block match is at sub-pixel precision. The interpolation results in a prediction of the block of the current picture. The prediction can further be refined by adding residual (prediction error). A reference picture is a picture that already have been coded and decompressed.

Interpolation is also used in so called B-prediction where samples of a reference block in one picture is added to samples of a reference block in another (or the same as the first) picture. Typically, the average between the blocks is used as the B-prediction. The B-prediction could also be formed by extrapolating the sample values from two blocks in two pictures into a third block in a third picture that follows the two first pictures. The B-prediction can further be refined by adding a residual.

Interpolation (and extrapolation) are also used for some modes in intra prediction where the prediction of the current block is constructed from interpolating between (or extrapolating from) bordering pixel values of neighbouring reference blocks. Also here, the prediction may be refined by adding a residual.

Filtering is also used in deblocking filters where edges between coding blocks are filtered to produce a more smooth transition between the blocks.

Configurable interpolation filters can also be applied, either for interpolation in inter prediction by so called adaptive interpolation filters, or in-loop (e.g. SAO—Sample Adaptive Offset or ALF—Adaptive Loop Filtering) or as a post filter.

Filtering is also used in weighted prediction wherein particular weighting factors are applied to one or more predictions to form a final prediction.

Filtering is also used when estimating the luminance from RGB samples, and when deriving YCbCr samples from RGB samples, deriving RGB samples from YUV samples, deriving XYZ samples from RGB samples etc. This kind of filtering typically takes place in pre-processing before coding or post-processing after coding but could also be used as part of encoding and decoding.

Interpolation is also used as part of the post-processing before display where samples are upsampled/downsampled from one resolution to another higher/lower resolution before display.

Interpolation is also used as part of post-processing when upsampling chroma components to same resolution as the luminance samples, e.g. conversion from YCb′Cr′ 4:2:0 to YCb′Cr′ 4:4:4.

In embodiments herein, to combat that interpolation of non-linear samples results in different interpolation property than if the filtering would have been applied on linear samples, the non-linear samples are converted to linear samples before filtering and/or interpolation and then the interpolated samples are converted back to non-linear samples.

In one embodiment, the method can be generalized as follows;
1. Sample values for more than one sample are transformed (i.e. converted) to a representation format that is different from the format that is used for representing the samples in the video.
2. Filtering is applied to the transformed values to obtain one or more new sample values.
3. A transform (i.e. conversion) is applied on the new sample value(s), which gives the resulting sample value(s).

It is possible, but not necessary, that the transform applied in step 3 is the inverse of the transform applied in step 1.

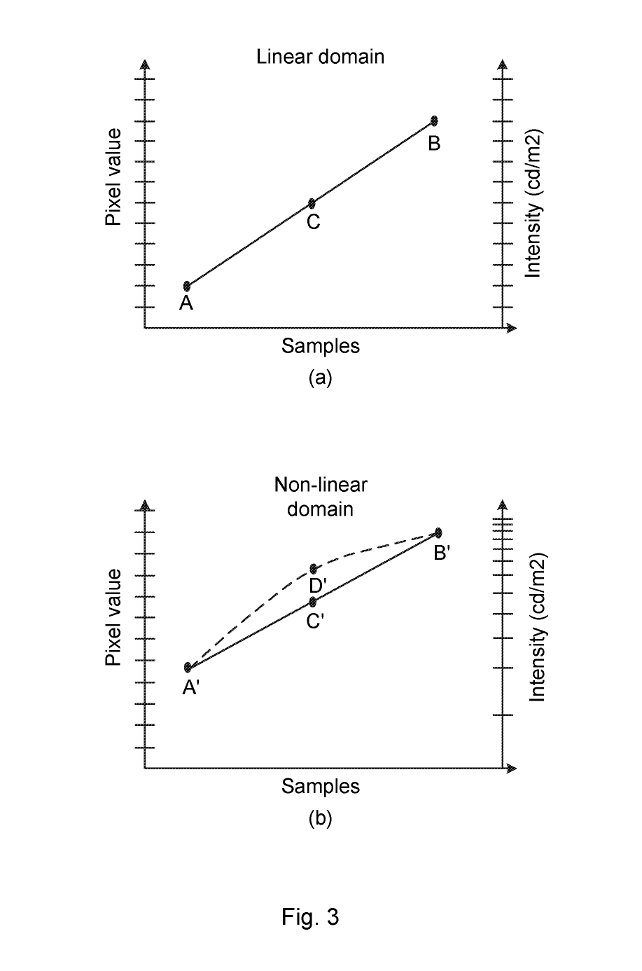

FIG. 3(a) illustrates interpolation of linear samples, and FIG. 3(b) illustrates two alternatives for interpolation of non-linear samples. The difference can be seen on the intensity scale on the right hand side of the graphs.

The dashed alternative in FIG. 3(b) maintains the linear properties of a signal after converting it to a linear domain, whereas the solid alternative does not.

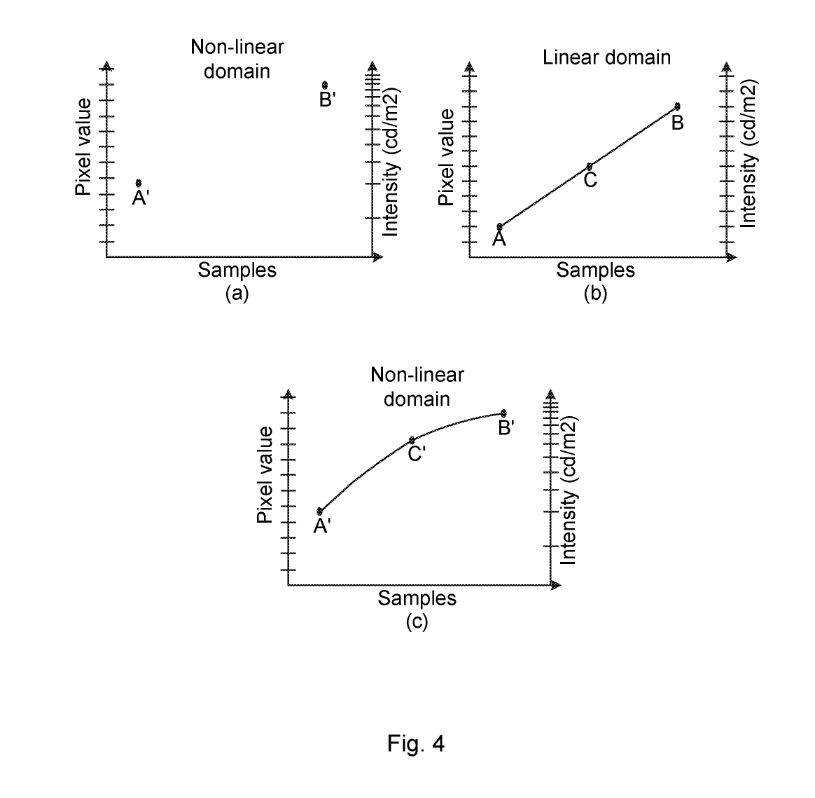

The special case where the filter is applied in linear domain is illustrated in FIG. 4. Before the samples of FIG. 4(a) are filtered, the non-linear samples of FIG. 4(a) are transformed to linear samples of FIG. 4(b); note the difference in intensity scales. The filter is then applied in the linear domain, in this case to generate point C. Finally, the filtered samples of FIG. 4(b) are transformed back to the original non-linear domain (FIG. 4(c)).

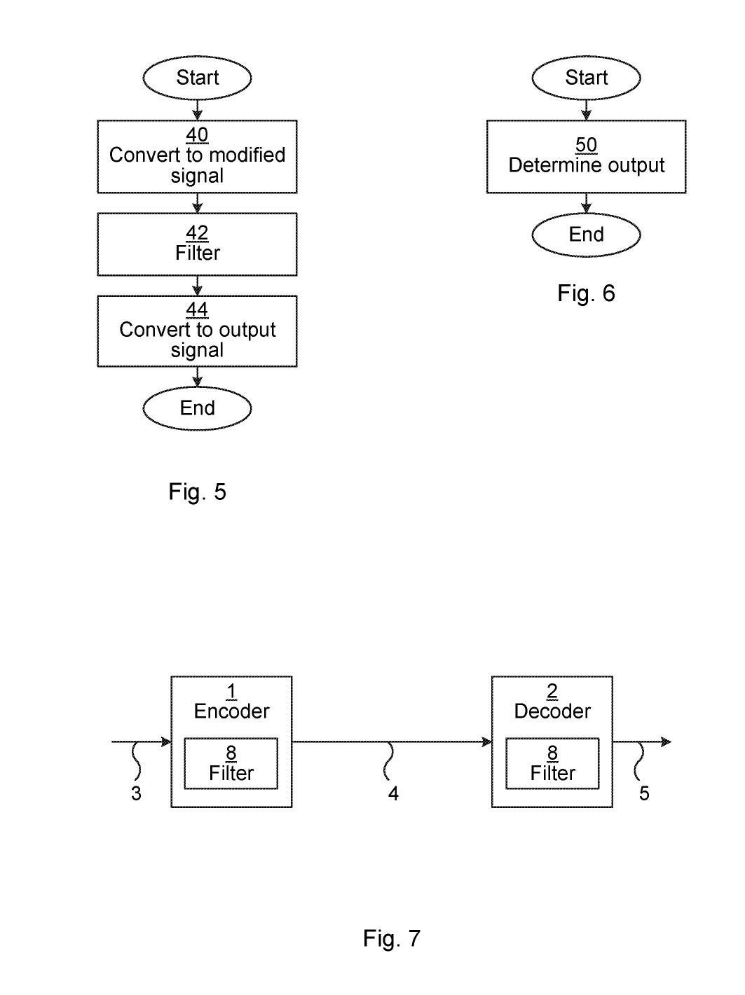

FIGS. 5 and 6 are flow chart illustrating embodiments of methods for applying a filter on at least one colour component of an input signal used for video processing. The video processing can e.g. be any one or more of encoding, decoding, pre-processing or post-processing.

Looking first to FIG. 5, this illustrates a method with two conversions and an intermediate filter.

In a convert to modified signal step 40, the input signal is converted, by applying a first conversion process, to a modified signal. Both the input signal and the modified signal are in a spatial domain. For instance, the input signal can comprise samples for a spatial element and the modified signal can comprise corresponding samples for a corresponding spatial element. Each such sample can be a pixel or a sub-pixel.

The modified signal can be a more linear representation of intensity of a physical entity than the input signal and the output signal.

For instance, the modified signal can be a colour and intensity representation in red, green and blue, RGB, and the input signal and the output signal is luma, blue-difference chroma and red difference chroma, YC_{B}C_{R}.

In a filter step 42, the modified signal is filtered with a filter. This yields a filtered signal. This comprises calculating values for each sample of the filtered signal, based on values for the samples in the modified signal.

In one embodiment, the filtering comprises applying a deblocking filter. De-blocking implies filtering samples across block boundaries of blocks of samples that are produced by different prediction parameters (related to for example inter prediction or intra prediction) or where the prediction error samples has been compressed lossy.

In one embodiment, the filtering comprises applying a weighted prediction wherein particular weighting factors and/or weighting offsets are applied to one or more predictions to form a final prediction. Prediction implies prediction of a block of samples in the current picture from another position in the current picture (intra prediction) or from another picture (inter prediction).

In one embodiment, the filtering comprises performing filtering for motion compensation using one reference or two references.

In one embodiment, the filtering comprises performing an intra prediction filtering process.

In one embodiment, the filtering comprises performing a resampling process between two different resolutions. This can e.g. comprise a chroma conversion between 4:4:4 and 4:2:2.

In one embodiment, the filtering comprises performing a conversion between two colour spaces.

In a convert to output signal step 44, the filtered signal is converted, by applying a second conversion process, to an output signal. Also the output signal is in a spatial domain. In one embodiment, the second conversion process is an inverse of the first conversion process.

The input signal and the output signal can be in a first representation and the modified signal can be in a second representation. The first representation is more compression efficient than the second representation and the second representation is more suitable than the first representation for applying filters.

An example of the method illustrated in FIG. 5 will now be described. This is an example when the samples are represented using Y′CbCr. Other color spaces could also be used such as ICtCp. Before encoding, the linear light representation RGB first goes through a nonlinear transfer function tf( ). An example of such a transfer function is tf(x)=x_{1/gamma}, where gamma=2.2. Another example of such a transfer function is the one used in SMPTE (Society of Motion Picture & Television Engineers) specification ST 2084, and included here for the convenience of the reader:

$$tf ( x ) = PQ\_TF ( max ( 0 , min ( R / 10000 , 1 ) ) , \\ where \\ PQ\_TF ( L ) = {( \frac{{c}_{1} + {c}_{2} {L}^{{m}_{1}}}{1 + {c}_{3} {L}^{{m}_{1}}} )}^{{m}_{2}} \\ {m}_{1} = \frac{2610}{4096} \times \frac{1}{4} = 0.1593017578125 \\ {m}_{2} = \frac{2523}{4096} \times 128 = 78.84375 \\ {c}_{1} = {c}_{3} - {c}_{2} + 1 = \frac{3424}{4096} = 0.8359375 \\ {c}_{2} = \frac{2413}{4096} \times 32 = 18.8515625 \\ {c}_{3} = \frac{2392}{4096} \times 32 = 18.6875$$

To convert from linear light RGB to Y′CbCr, the first step is to apply the transfer function to each component:

R′=tf(R)

G′=tf(G)

B′=tf(B)

Next, the Y′CbCr can be obtained using

Y′=0.262700*R′+0.678000*G′+0.059300*B′

Cb=−0.139630*R′−0.360370*G′+0.500000*B′

Cr=0.500000*R′−0.459786*G′−0.040214*B′

if the BT.2020 color space is used. (The formula for, e.g., Rec.709, similar.). The next step may be to subsample the Cb and Cr components. In this illustrative example however, we assume that Cb and Cr are full resolution, i.e., we are operating in Y′CbCr4:4:4.

According to prior art, two pixels would be interpolated component by component. As an example, if we have two colors (Y′1, Cb1, Cr1) and (Y′2, Cb2, Cr2) that we wish to interpolate these two values with equal weights, a new, averaged color (Y′a, Cba, Cra) would be calculated as:

Y′a=(Y′1+Y′2)/2

Cba=(Cb1+Cb2)/2

Cra=(Cr1+Cr2)/2

According to one embodiment of the present invention, we perform the filter instead on RGB values according to the following procedure (here we assume BT.2020 color space):

R1′=clipRGB(Y1+1.47460*Cr1)

G1′=clipRGB(Y1−0.16455*Cb1−0.57135*Cr1)

B1′=clipRGB(Y1+1.88140*Cb1)

R2′=clipRGB(Y′2+1.47460*Cr2)

G2′=clipRGB(Y′2−0.16455*Cb2−0.57135*Cr2)

B2′=clipRGB(Y′2+1.88140*Cb2),

where clipRGB(x)=Clip3(0, 1, x), and Clip3(x,y,z)=x if z<x, y if z>y, z otherwise. Next, the inverse tf⁻¹( ) of the transfer function is applied to get linear data, corresponding to the convert to modified signal step 40.

R1=tf⁻¹(R1′)

G1=tf⁻¹(G1′)

B1=tf⁻¹(B1′)

R2=tf⁻¹(R2′)

G2=tf⁻¹(G2′)

B2=tf⁻¹(B2′)

Corresponding to the filter step 42, it is now possible to average the two colors with equal weights:

Ra=(R1+R2)/2

Ga=(G1+G2)/2

Ba=(B1+B2)/2

And, corresponding to the convert to output signal step 44, to go back to Y′CbCr:

Ra′=tf(Ra)

Ga′=tf(Ga)

Ba′=tf(Ba)

Next, the Y′CbCr can be obtained using

YA′=0.262700*Ra′+0.678000*Ga′+0.059300*Ba′

CbA=−0.139630*Ra′−0.360370*Ga′+0.500000*Ba′

CrA=0.500000*Ra′−0.459786*Ga′−0.040214*Ba′

The resulting color (YA′, CbA, CrA) using this embodiment will not be the same as the one created using prior art (Y′a, Cba, Cra), but will be more true to what a real interpolation should look like. As an example, the interpolation used in prior art (in the non-linear domain) will favor dark colors, rendering the end result darker than it should. The correctly averaged color (YA′, CbA, CrA) where the filtering is performed in the linear domain, will not have this problem.

It should be understood that although this example has used equal weights of two pixels, the same method applies to unequal weights of several pixels and also for the use of some negative weights. In other words, the filtering in the linear domain can be any suitable filter operation.

The presented operations of transforming to a linear space, averaging, and transforming back again to a non-linear space may be computationally expensive. Therefore, in another embodiment, these operations are only done for some pixels.

As an example, if we are going to filter two samples (e.g. average two blocks (B-prediction)), we can compare each sample pair (Y′1, Cb1, Cr1) and (Y′2, Cb2, Cr2). If they are significantly different, e.g., if (Y′1-Y′2)²+(Cb1-Cb2)²+(Cr1-Cr2)² is larger than a threshold value, the pixels are converted to linear light before being filtered. Otherwise, the previous art method of averaging is used. Another possibility is to decide this on a block level.

Another way to reduce the computational complexity is to choose a transformation that does not take the color to a linear domain, but still is better than using prior art averaging. As an example, one may use

Y′a=tf((tf⁻¹(Y′l)+tf⁻¹(Y′2))/2)

Cba=(Cb1+Cb2)/2

Cra=(Cr1+Cr2)/2

In this case, the transfer function is applied only on the Y-component. This works well when the chrominance components are small. Indeed, if they are zero, we get exactly the same result as in the more computationally expensive cases described above.

Looking now to FIG. 6, this illustrates a method with a single determination corresponding to conversions and an intermediate filter.

In a determine output step 50, an output is determined using a lookup table. The output corresponds to an approximation of an output obtained by the method illustrated in FIG. 5 and explained above. In other words, the output corresponds to an approximation of an output obtained by converting the input signal, by applying a first conversion process, to a modified signal, wherein both the input signal and the modified signal are in a spatial domain; filtering the modified signal with a filter, yielding a filtered signal; and converting the filtered signal, by applying a second conversion process, to the output signal, wherein the output signal is in a spatial domain.

In one embodiment, the determining an output comprises the use of the following formula:

$$vo = \frac{\begin{matrix}w 1 ( 1 ) * lookuptable ( v ( 1 ) / step ) * v ( 1 ) + \\ w 1 ( 2 ) * lookuptable ( v ( 2 ) / step ) * v ( 2 )\end{matrix}}{\begin{matrix}w 1 ( 1 ) * lookuptable ( v ( 1 ) / step ) + \\ w 1 ( 2 ) * lookuptable ( v ( 2 ) / step )\end{matrix}} ,$$

where vo is the output, w1 is a vector for filter coefficients, v is a vector of the input signal and step is the distance between values of the lookup table.

In one embodiment, the determining an output comprises the use of the following formula:

$$vo = \frac{{\sum }_{n = 0}^{N - 1} w 1 ( n ) * lookuptable ( v ( n ) / step ) * v ( n )}{{\sum }_{n = 0}^{N - 1} w 1 ( n ) * lookuptable ( v ( n ) / step )}$$

where, in addition to the parameters of the preceding formula, N is the length of the filter w1.

It should be understood that although this example has used a one dimensional filter the method also applies to two dimensional filters and other dimensions of filters.

As explained above, the modified signal can be a more linear representation of intensity of a physical entity than the input signal and the output signal.

According to one embodiment, the interpolation is done on non-linear samples with a modification of the filter coefficients such that they better correspond to interpolation of linear samples after the interpolated non-linear samples have been converted to linear samples.

One approach to generate modified filter coefficients is described in the steps below:
1. Generate a table with weights denoted lookUpTable. The table contains a set of increasing weights with increasing indices. The weights are set such that they cover the range of non-linear values, for example between 0 and 1. An example table is lookUpTable=[0.1 0.2 0.3 0.4 0.5 0.6 0.7 0.8 0.9 1.0]. An entry in the table corresponds to a non-linear value. In this case the first entry is 0 and the last entry is 9. The entry is given by the non-linear input value divided by ‘step’. Given that non-linear values are between 0 and 1, and the length of the table is 10, the non-linear value is divided by 1/(10−1), i.e. step=0.1111. Thus, entries between 0 and 9 can be generated from a non-linear value. If the non-linear values are given with 10 bit accuracy (which could be the case for samples to be compressed by video coding) the step is (2̂(10)−1)*0.1111=1023*0.1111=113.6553.
2. Determine filter coefficients in the non-linear domain given the above table and filter coefficients in the linear domain.

An example of filtering is bilinear filtering for quarter-pel interpolation, e.g. w1=[0.25 0.75]. It should be understood that although this example has used unequal weights of two pixels, the same method applies to equal weights of several pixels and also for the use of some negative weights.
3. Determine modified filter coefficients in the non-linear domain, as w2(1) and w2(2) based on filter coefficients in the linear domain w1(1) and w1(2). w2(1) and w2(2) are determined from the to be filtered non-linear values v(1) respectively v(2) and are then used to generate a filtered value output sample vo:

w2(1)=w1(1)*lookUpTable(v(1)/step)

w2(2)=w1(2)*lookUpTable(v(2)/step)

vo=(w2(1)*v(1)+w2(2)*v(2))/(w2(1)+w2(2))

This can also be written as:

v0=w3(1)*v(1)+w3(2)*v(2)

where w3(1)=w2(1)/(w2(1)+w2(2)) and w3(2)=w2(2)/(w2(1)+w2(2))

It can be noted that the multiplication by a linear filter coefficient and the table, i.e. w1(1)*lookUpTable(i), can be replaced by another table wLookUpTable to avoid the multiplication.

The lookUpTable can be optimized offline to give a desired performance for the range of input samples. One approach to optimize performance is to find a value of alpha where the lookUpTable is modified for respective entry by lookUpTable(i)̂alpha. A larger table can also be considered.

Given that a more computationally efficient implementation can be performed in fixed point numbers than in floating point numbers one can convert floating point numbers to fixed point numbers and perform the computations with fixed point numbers. For example, the step can be quantized to a value which is a multiple of 2 then the division can be performed by a right shift (x>>m=x/(2̂m)). Alternatively, one can multiply x with a value n before right shift (x*n>>m). The division with the sum of the new filter coefficients w2 can also be replaced by a right shift only or a multiplication and right shift, when the new filter coefficients also are given with fixed point numbers instead of floating point.

According to another embodiment, a polynomial model of the non-linear values can be used when determining the modified filter coefficients in the non-linear domain as:

w2(1)=w1(1)*(1*v(1)+k)

w2(2)=w1(2)*(1*v(2)+k)

where k is an additive offset to avoid biasing the output to a single non-zero value and 1 is a scaling factor. The scaling factor can optionally be omitted. It should be understood that although this example has used a first order polynomial model to determine the modified filter coefficients other orders of polynomial models could also be used.

### Interpolation/Extrapolation on Non-Linear Samples Using a DC Offset

In another embodiment, an additive term, DC offset, is added to interpolation of non-linear samples to compensate for a difference in interpolation on linear samples and interpolation on non-linear samples.

In what follows is a filtering example according to this embodiment.

Assume the input samples from a video source, such as a camera, are [100 0] and the maximum value is 255 (maxvalIN).

Applying a half-pixel bi-linear interpolation filter [1 1]/2 on the input samples would give 50.

Applying a non-linearity on the input samples for example maxvalCOD*(x/maxvalIN)̂(½) produces the non-linear samples [160 0], where maxvalCOD is the max value of the representation for the non-linear samples in the example and 255 is used here as the maxvalCOD corresponding to 8 bit samples.

Filtering the non-linear samples with a half-pixel bi-linear interpolation filter [1 1]/2 for the two middle samples gives 80. Then after inverse non-linearity maxvalIN*(x/maxvalCOD)̂2 the final result would be 25.

According to one embodiment, applying same filtering after inverse non-linearity of the non-linear samples and apply the filter there the final result would have been 50. Then, after again converting to the non-linear domain by x̂(½) the result would be about 113.

According to one embodiment, the filter coefficients for the interpolation on the non-linear samples can be modified according to the non-linear sample values. In this example the following modified filter coefficients can be used; [0.7079 0.2921]. The modified filter coefficients were derived from a table lookup using the following lookUpTable:

lookUpTable=[0.10.2 0.3 0.4 0.5 0.6 0.7 0.8 0.9 1.0]̂0.455]=[0.3508 0.4808 0.5782 0.6591 0.7295 0.7926 0.8502 0.9035 0.9532 1.0]

The non-linear sample equal to 160 is divided by the step which in this case is 255/(10−1) which after rounding gives index 6 in the table which has the value 0.8502. The non-linear sample equal to 0 is divided by the step gives index 0 which has the value 0.3508. The modified filter coefficients in the non-linear domain in this example are thus [0.8502*0.5 0.3508*0.5]/(0.5*(0.8502+0.3505))=[0.7079 0.2921]. Filtering the non-linear samples gives, after rounding, 113 in the non-linear sample domain (corresponding to 50 in the input sample domain which is same as if the filtering would have been performed on the input samples).

FIG. 7 is a schematic diagram illustrating an environment with an encoder and a decoder, in which embodiments presented herein can be implemented. An encoder 1 is used to encode input video 3 to a bitstream 4 comprising encoded video. The bitstream 4 is transferred to the decoder e.g. using a network connection or using physical media. The decoder 2 reads and decodes the bitstream 4 to produce output video 5 which corresponds to the input video stream 3. The encoding can be lossy, whereby the output video 5 is not identical to the input video 3. The perceived quality loss depends on the bitrate of the bitstream 4; when the bitrate is high, the encoder can produce a bitstream which allows a better quality output video 5.

The video encoding/decoding can e.g. comply with any one of HEVC (High Efficiency Video Coding), MPEG (Moving Pictures Expert Group)-4, H.263, H.264, and MPEG-2, etc. It is to be understood by a person skilled in the art that the video encoding/decoding could also comply with future video coding standards as well as third-party implementations.

By providing a bitstream with reduced bitrate requirements, the resulting output video 5 can be generated with higher quality. Alternatively (or additionally), less bandwidth is needed for the bitstream 4. It is thus a benefit to increase encoding efficiency.

Each one of the encoder 1 and the decoder 2 comprises a filter device 8. As explained above, the filter device can be used as part of encoding, decoding, pre-processing, video editing, or any other video processing purpose. The filter may share hardware and/or software with other parts of the encoder 1/decoder 2.

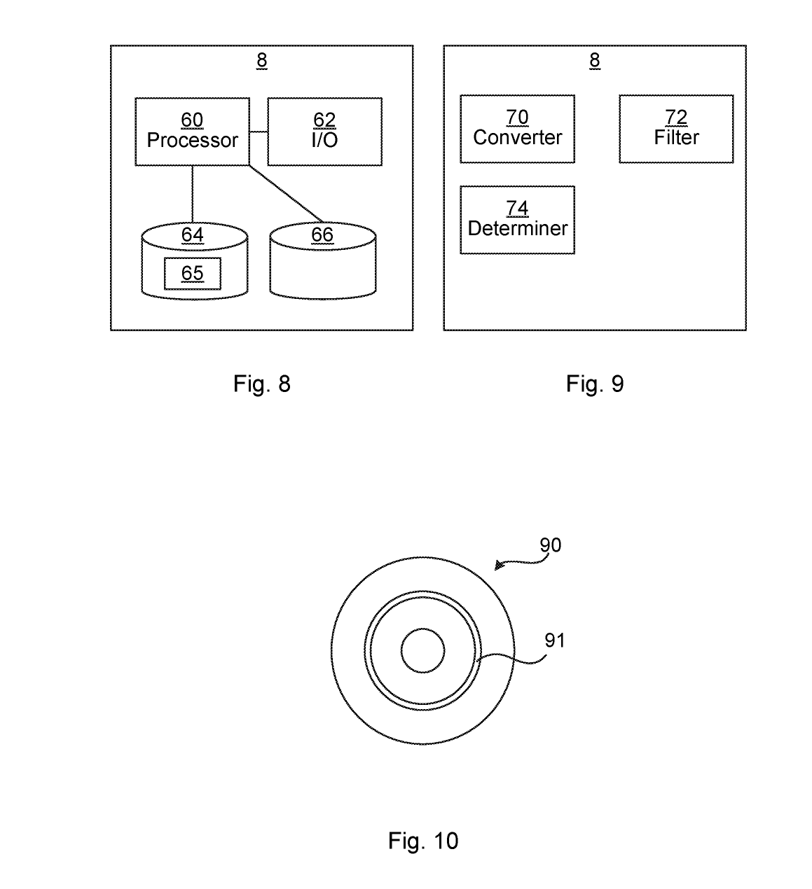

FIG. 8 is a schematic diagram showing some components of the filter device 8 of FIG. 7. A processing means 60 is provided using any combination of one or more of a suitable central processing unit (CPU), multiprocessor, microcontroller, digital signal processor (DSP), application specific integrated circuit etc., capable of executing software instructions 65 stored in a memory 64, which can thus be a computer program product. The processor 60 can be configured to execute the method described with reference to FIGS. 5-6 above.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 66 is also provided for reading and/or storing data during execution of software instructions in the processor 60. The data memory 66 can be any combination of read and write memory (RAM) and read only memory (ROM).

The filter device 8 further comprises an I/O interface 62 for communicating with other external entities. Optionally, the I/O interface 62 also includes a user interface for local or remote access.

Other components of the filter device 8 are omitted in order not to obscure the concepts presented herein.

When the filter device 8 device forms part of a host device, such as the encoder 1 or decoder 2 of FIG. 7, the filter device may share all or some of its hardware and/or software with the host device.

FIG. 9 is a schematic diagram showing functional modules of the decoder 2 of FIG. 1 according to one embodiment. The modules are implemented using software instructions such as a computer program executing in the filter device. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 5 and 6.

A converter 70 corresponds to steps 40 and 44. A filter 72 corresponds to step 42. A determiner 74 corresponds to step 50.

FIG. 10 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 64 of FIG. 8.

While the computer program 91 is here schematically shown as a track on the depicted optical disk, the computer program can be stored in any way which is suitable for the computer program product, such as a removable solid state memory, e.g. a Universal Serial Bus (USB) drive.

Here now follows another perspective of embodiments, presented using various aspects.

Interpolation of non-linear samples that eventually are intended for display fails to maintain a certain interpolation filter property, like half-pel or quarter-pel interpolation, as would have resulted from interpolating linear samples. This is illustrated in FIG. 3. Namely, FIG. 3(a) illustrates and example where a sample C=6 is interpolated from samples A=2 and B=10 in the linear domain, whereas FIG. 3(b) shows samples A and B that have been converted to a non-linear domain into A′=5 and B′=11. When interpolating between samples A′ and B′ using the same interpolation filter the sample C′=8, even though the intensity scale is no longer linear. To maintain the linear properties when going back to the linear domain sample D′=9 should have been selected instead. Thus, the interpolation filter property is not maintained when applied in a non-linear linear domain. Also, in this example, any prediction error in the higher pixel value range would be magnified compared to the same prediction error in the lower pixel value range.

One idea of embodiments of the present invention is to adapt the filtering method applied on non-linear samples such that the filter responses after conversion to linear samples are similar to a filtering done on linear samples.

An aspect of the embodiments defines a method for filtering at least one sample of a signal S2 comprising non-linear samples, the method comprising the following steps:
Converting the signal S2 to a signal S1 by applying a transform, wherein the signal S1 comprises linear samples
Filtering at least one sample of S1 with a filter F1 having filter coefficients W1
Converting back the filtered signal S1 by applying an inverse transform to create a filtered signal S2.

Another aspect of the embodiments defines a method for filtering at least one sample of a signal S2 comprising non-linear samples, the method comprising the following steps:
Filtering at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

Another aspect of the embodiments defines a filter for filtering at least one sample of a signal S2 comprising non-linear samples, the filter comprising processing means and a memory comprising instructions which, when executed by the processing means, causes the filter to:
Convert the signal S2 to a signal S1 by applying a transform, wherein the signal S1 comprises linear samples
Filter at least one sample of S1 with a filter F1 having filter coefficients W1
Convert back the filtered signal S1 by applying an inverse transform to create a filtered signal S2.

The filter could also comprise a converting means, configured to convert the signal S2 to a signal S1 by applying a transform and to convert back the filtered signal S1 by applying an inverse transform, and a filtering means configured to filter at least one sample of S1 with a filter F1 having filter coefficients W1.

Yet another aspect of the embodiments defines a filter for filtering at least one sample of a signal S2 comprising non-linear samples, the filter comprising processing means and a memory comprising instructions which, when executed by the processing means, causes the filter to:

Filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

The filter could also comprise a filtering means configured to filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

The filter may be implemented in hardware, in software or a combination of hardware and software. The encoder may be implemented in, e.g. comprised in, user equipment, such as a mobile telephone, tablet, desktop, netbook, multimedia player, video streaming server, set-top box or computer.

A further aspect of the embodiments defines a computer program for a filter comprising a computer program code which, when executed, causes the filter to:
Convert the signal S2 to a signal S1 by applying a transform, wherein the signal S1 comprises linear samples
Filter at least one sample of S1 with a filter F1 having filter coefficients W1
Convert back the filtered signal S1 by applying an inverse transform to create a filtered signal S2.

A further aspect of the embodiments defines a computer program for a filter comprising a computer program code which, when executed, causes the filter to:
Filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

A further aspect of the embodiments defines a computer program product for a filter comprising a computer program for a filter and a computer readable means on which the computer program for a filter is stored.

An aspect of the embodiments defines a method, performed by an encoder, for filtering at least one sample of a signal S2 comprising non-linear samples, the method comprising the following steps:
Converting the signal S2 to a signal S1 by applying a transform, wherein the signal S1 comprises linear samples
Filtering at least one sample of S1 with a filter F1 having filter coefficients W1
Converting back the filtered signal S1 by applying an inverse transform to create a filtered signal S2.

Yet another aspect of the embodiments defines a method, performed by an encoder, for filtering at least one sample of a signal S2 comprising non-linear samples, the method comprising the following steps:
Filtering at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

Another aspect of the embodiments defines an encoder, the encoder comprising processing means and a memory comprising instructions which, when executed by the processing means, causes the encoder to:
Convert the signal S2 to a signal S1 by applying a transform, wherein the signal S1 comprises linear samples
Filter at least one sample of S1 with a filter F1 having filter coefficients W1
Convert back the filtered signal S1 by applying an inverse transform to create a filtered signal S2.

The encoder could also comprise a converting means, configured to convert the signal S2 to a signal S1 by applying a transform and to convert back the filtered signal S1 by applying an inverse transform, and a filtering means configured to filter at least one sample of S1 with a filter F1 having filter coefficients W1.

Another aspect of the embodiments defines an encoder, the encoder comprising processing means and a memory comprising instructions which, when executed by the processing means, causes the encoder to:
Filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

The encoder could also comprise a filtering means configured to filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

The encoder may be implemented in hardware, in software or a combination of hardware and software. The encoder may be implemented in, e.g. comprised in, user equipment, such as a mobile telephone, tablet, desktop, netbook, multimedia player, video streaming server, set-top box or computer.

A further aspect of the embodiments defines a computer program for an encoder comprising a computer program code which, when executed, causes the encoder to:
Convert the signal S2 to a signal S1 by applying a transform, wherein the signal S1 comprises linear samples
Filter at least one sample of S1 with a filter F1 having filter coefficients W1
Convert back the filtered signal S1 by applying an inverse transform to create a filtered signal S2.

A further aspect of the embodiments defines a computer program for an encoder comprising a computer program code which, when executed, causes the encoder to:
Filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

A further aspect of the embodiments defines a computer program product for an encoder comprising a computer program for a filter and a computer readable means on which the computer program for an encoder is stored.

An aspect of the embodiments defines a method, performed by a decoder, for filtering at least one sample of a signal S2 comprising non-linear samples, the method comprising the following steps:
Converting the signal S2 to a signal S1 by applying a transform, wherein the signal S1 comprises linear samples
Filtering at least one sample of S1 with a filter F1 having filter coefficients W1
Converting back the filtered signal S1 by applying an inverse transform to create a filtered signal S2.

Yet another aspect of the embodiments defines a method, performed by a decoder, for filtering at least one sample of a signal S2 comprising non-linear samples, the method comprising the following steps:
Filtering at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

Another aspect of the embodiments defines a decoder, the decoder comprising processing means and a memory comprising instructions which, when executed by the processing means, causes the decoder to:
Convert the signal S2 to a signal S1 by applying a transform, wherein the signal S1 comprises linear samples
Filter at least one sample of S1 with a filter F1 having filter coefficients W1
Convert back the filtered signal S1 by applying an inverse transform to create a filtered signal S2.

The decoder could also comprise a converting means, configured to convert the signal S2 to a signal S1 by applying a transform and to convert back the filtered signal S1 by applying an inverse transform, and a filtering means configured to filter at least one sample of S1 with a filter F1 having filter coefficients W1.

Another aspect of the embodiments defines a decoder, the decoder comprising processing means and a memory comprising instructions which, when executed by the processing means, causes the decoder to:
Filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

The decoder could also comprise a filtering means configured to filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

The decoder may be implemented in hardware, in software or a combination of hardware and software. The encoder may be implemented in, e.g. comprised in, user equipment, such as a mobile telephone, tablet, desktop, netbook, multimedia player, video streaming server, set-top box or computer.

A further aspect of the embodiments defines a computer program for a decoder comprising a computer program code which, when executed, causes the decoder to:
Convert the signal S2 to a signal S1 by applying a transform, wherein the signal S1 comprises linear samples
Filter at least one sample of S1 with a filter F1 having filter coefficients W1
Convert back the filtered signal S1 by applying an inverse transform to create a filtered signal S2.

A further aspect of the embodiments defines a computer program for a decoder comprising a computer program code which, when executed, causes the decoder to:
Filter at least one sample of S2 with a filter F2 having filter coefficients W2, wherein the difference between the at least one filtered sample and a filtered sample produced by first converting S2 by a transform to a signal S1, followed by filtering the signal S1 with a filter F1 having filter coefficients W1 and inverse transforming S1 is smaller than the difference between the at least one filtered sample and the filtered sample produced by filtering S2 with a filter F1 with filter coefficients W1, wherein the signal S1 comprises linear samples.

A further aspect of the embodiments defines a computer program product for a decoder comprising a computer program for a filter and a computer readable means on which the computer program for a decoder is stored.

The main advantage of the embodiments of the present invention is that non-linear samples can be filtered according to a given filter property (e.g. interpolation or extrapolation property) in linear domain. By doing so, the prediction from the filter may be more accurate and the prediction errors may be equally weighted.

The invention has mainly been described above with reference to a few embodiments. However, as is readily appreciated by a person skilled in the art, other embodiments than the ones disclosed above are equally possible within the scope of the invention, as defined by the appended patent claims.

1. A method for applying a filter on at least one colour component of an input signal used for video processing, the method being performed in a filter device and comprising the steps of:
converting the input signal to a modified signal, wherein both the input signal and the modified signal are in a spatial domain, and wherein the converting of the input signal to the modified signal comprises applying a first conversion process;
filtering the modified signal with a filter, yielding a filtered signal; and
converting the filtered signal to an output signal, wherein the output signal is in a spatial domain, and wherein converting the filtered signal to the output signal comprises applying a second conversion process.

2. (canceled)

3. The method of claim 1, wherein the second conversion process is an inverse of the first conversion process.

4. (canceled)

5. The method of claim 1, wherein the modified signal is a colour and intensity representation in red, green and blue (RGB), and the input signal and the output signal is luma, blue-difference chroma and red difference chroma, YC_{B}C_{R}.

6. The method of claim 1, wherein the input signal comprises samples for a spatial element and wherein the modified signal comprises corresponding samples for a corresponding spatial element.

7. The method of claim 6, wherein the step of filtering comprises at least one of:
calculating values for each sample of the filtered signal, based on values for the samples in the modified signal,
applying a de-blocking filter,
applying a weighted prediction wherein particular weighting factors and/or weighting offsets are applied to one or more predictions to form a final prediction,
performing filtering for motion compensation using one reference or two references,
performing an intra prediction filtering process,
performing a resampling process between two different resolutions, and
performing a conversion between two colour spaces.

8-13. (canceled)

14. A filter device for applying a filter on at least one colour component of an input signal used for video processing, the filter device comprising processing means and a memory comprising instructions which, when executed by the processing means, causes the filter device to:
convert the input signal to a modified signal by applying a first conversion process, wherein both the input signal and the modified signal are in a spatial domain;
filter the modified signal with a filter, yielding a filtered signal; and
convert the filtered signal to an output signal by applying a second conversion process, wherein the output signal is in a spatial domain.

15. (canceled)

16. The filter device of claim 14, wherein the second conversion process is an inverse of the first conversion process.

17. The filter device of claim 14, wherein the modified signal is a more linear representation of intensity of a physical entity than the input signal and the output signal.

18. The filter device of claim 17, wherein the modified signal is a colour and intensity representation in red, green and blue (RGB), and the input signal and the output signal is luma, blue-difference chroma and red difference chroma, YC_{B}C_{R}.

19. The filter device of claim 14, wherein the input signal comprises samples for a spatial element and wherein the modified signal comprises corresponding samples for a corresponding spatial element.

20. The filter device of claim 19, wherein the instructions to filter comprise instructions which, when executed by the processing means, causes the filter device to perform at least one of:
calculate values for each sample of the filtered signal, based on values for the samples in the modified signal,
apply a de-blocking filter,
apply a weighted prediction wherein particular weighting factors and/or weighting offsets are applied to one or more predictions to form a final prediction,
perform filtering for motion compensation using one reference or two references,
perform an intra prediction filtering process,
perform a resampling process between two different resolutions, and
perform a conversion between two colour spaces.

21-29. (canceled)

30. A computer program product comprising a non-transitory computer readable medium comprising computer program for applying a filter on at least one colour component of an input signal used for video processing, the computer program comprising computer program code which, when run on a filter device causes the filter device to perform the method of claim 1.

31. (canceled)

32. A method for applying a filter on at least one colour component of an input signal used for video processing, the method being performed in a filter device (1, 2) and comprising the steps of:
determining an output using a lookup table, wherein the output corresponds to an approximation of an output obtained by:
converting the input signal to a modified signal by applying a first conversion process, wherein both the input signal and the modified signal are in a spatial domain;
filtering the modified signal with a filter, yielding a filtered signal; and
converting the filtered signal to the output signal by applying a second conversion process, wherein the output signal is in a spatial domain.

33. The method of claim 32, wherein the step of determining an output comprises the use of the following formula:
$$vo = \frac{{\sum }_{n = 0}^{N - 1} w 1 ( n ) * lookuptable ( v ( n ) / step ) * v ( n )}{{\sum }_{n = 0}^{N - 1} w 1 ( n ) * lookuptable ( v ( n ) / step )} ,$$
where vo is the output, w1 is a vector for filter coefficients, N is the length of the filter w1, v is a vector of the input signal and step is the distance between values of the lookup table.

34. The method of claim 32, wherein the modified signal is a more linear representation of intensity of a physical entity than the input signal and the output signal.

35-38. (canceled)

39. A computer program product comprising a non-transitory computer readable medium comprising computer program for applying a filter on at least one colour component of an input signal used for video processing, the computer program comprising computer program code which, when run on a filter device causes the filter device to perform the method of claim 32.

40. (canceled)
